(19) United States
(12) Patent Application Publication
(10) Pub. No.: US 2025/0141054 A1
(43) Pub. Date: May 1, 2025

(54) ASSEMBLY

(71) Applicant: Yazaki Corporation, Tokyo (JP)

(72) Inventors: Yasuhiro KOMINATO, Makinohara-shi (JP); Takahiko KATSURAMAKI, Makinohara-shi (JP); Ryoichi MURATA, Makinohara-shi (JP)

(73) Assignee: Yazaki Corporation, Tokyo (JP)

(21) Appl. No.: 18/917,125

(22) Filed: Oct. 16, 2024

(30) Foreign Application Priority Data
Oct. 30, 2023 (JP) 2023-185171

(51) Int. Cl. H01M 50/507

(52) U.S. Cl. CPC H01M 50/507

(57) ABSTRACT

An assembly according to an embodiment includes: a device unit including a device having a first installation surface and a device busbar including a first extending portion extending in contact with the first installation surface and a first connecting portion extending continuously from the first extending portion; and a battery unit including a battery pack having a second installation surface facing the first installation surface and a battery busbar including a second extending portion extending in contact with the second installation surface and a second connecting portion extending continuously from the second extending portion and connectable to the first connecting portion, in which a gap is formed at least one of between the first installation surface and the first connecting portion and between the second installation surface and the second connecting portion.

### BACKGROUND OF THE INVENTION

### Field of the Invention

Embodiments of the present invention relate to an assembly. Priority is claimed on Japanese Patent Application No. 2023-185171, filed Oct. 30, 2023, the contents of which are incorporated herein by reference.

### Description of Related Art

It is widely known that a battery unit as a power supply source is connected to a device. For example, Japanese Unexamined Patent Application, First Publication No. 2018-144524 discloses that a battery module is connected to a fuse/contactor unit of an electric vehicle.

### SUMMARY OF THE INVENTION

In an assembly disclosed in Japanese Unexamined Patent Application, First Publication No. 2018-144524, a male-side power supply-side terminal portion disposed in a battery module is attached to and detached from each of a plurality of female-side power reception-side terminal portions connected to the fuse/contactor unit. However, in such a connection structure using the terminal portions, the contact pressure between connecting portions cannot be ensured in some cases.

An embodiment of the present invention provides an assembly that easily ensures contact pressure between connecting portions.

An assembly according to an embodiment of the present invention includes: a device unit including a device having a first installation surface and a device busbar including a first extending portion extending in contact with the first installation surface and a first connecting portion extending continuously from the first extending portion; and a battery unit including a battery pack having a second installation surface facing the first installation surface and a battery busbar including a second extending portion extending in contact with the second installation surface and a second connecting portion extending continuously from the second extending portion and connectable to the first connecting portion, in which a gap is formed at least one of between the first installation surface and the first connecting portion and between the second installation surface and the second connecting portion.

According to an assembly of an embodiment of the present invention, it is easy to ensure contact pressure between connecting portions.

### BRIEF DESCRIPTION OF THE DRAWINGS

FIG. 1 is a front view of an assembly before fastening according to each of embodiments.

FIG. 2 is a cross-sectional view of an assembly before fastening according to a first embodiment, taken along line II-II in FIG. 1.

FIG. 3 is a cross-sectional view of the assembly after fastening according to the first embodiment, taken along line II-II in FIG. 1.

FIG. 4 is a cross-sectional view of an assembly before fastening according to a modification of the first embodiment, taken along line II-II in FIG. 1.

FIG. 5 is a cross-sectional view of an assembly before fastening according to a second embodiment, taken along line II-II in FIG. 1.

FIG. 6 is a cross-sectional view of the assembly after fastening according to the second embodiment, taken along line II-II in FIG. 1.

FIG. 7 is a cross-sectional view of an assembly before fastening according to a modification of the second embodiment, taken along line II-II in FIG. 1.

FIG. 8 is a perspective view of an assembly before fastening according to a modification of each of the embodiments.

### DETAILED DESCRIPTION OF THE INVENTION

### First Embodiment

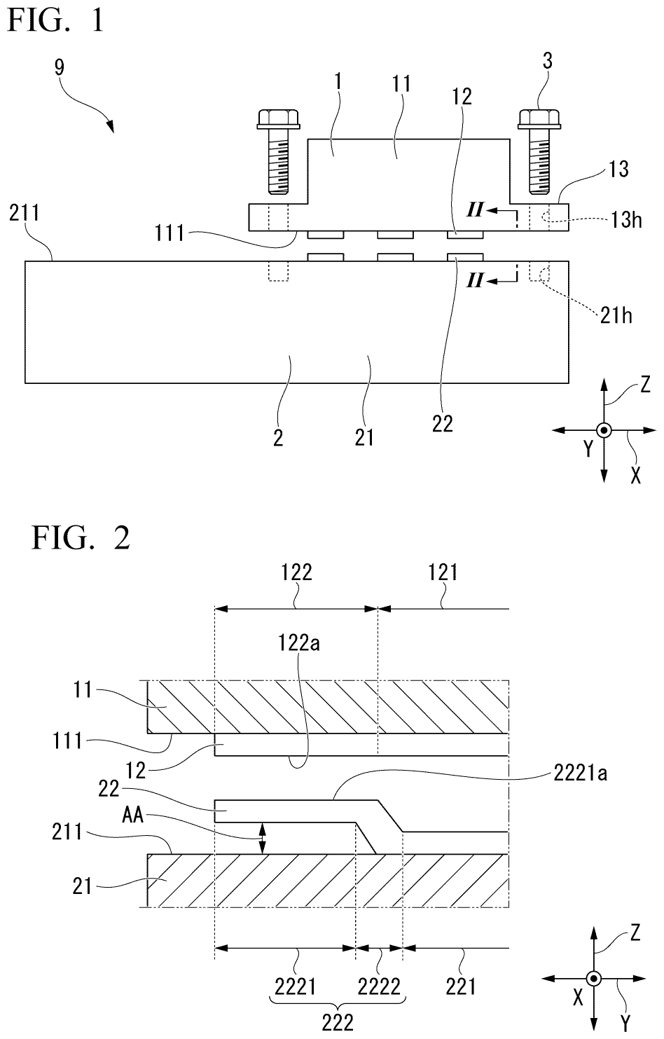

Hereinafter, an assembly according to an embodiment will be described with reference to FIGS. 1 to 4.

### (Configuration of Assembly)

As illustrated in FIG. 1, an assembly 9 of the present embodiment includes a device unit 1, a battery unit 2, and a fastening material 3. The device unit 1 and the battery unit 2 are fastened by the fastening material 3, whereby the assembly 9 is unitized. For example, the assembly 9 may be mounted on a mobility unit such as an electric vehicle.

### (Configuration of Device Unit)

The device unit 1 includes a device 11, a plurality of device busbars 12, and a flange portion 13.

### (Device)

The device 11 receives power from the battery unit 2. For example, the device 11 may be a high-voltage device such as a high-voltage junction box (J/B), an on-board charger (OBC), or a DC-DC converter. The device 11 has a first installation surface 111 on a side facing the battery unit 2.

Hereinafter, a direction parallel to a direction in which the first installation surface 111 faces is referred to as a Z direction. Directions intersecting with each other in a plane facing the Z direction are defined as an X direction and a Y direction. For example, the X direction, the Y direction, and the Z direction may be directions orthogonal to each other. For example, the Z direction may be an “up-down direction”. For example, the first installation surface 111 may be a plane facing downward.

The first installation surface 111 is an insulating surface made of an insulator material. For example, the first installation surface 111 may be a housing having insulation properties, a cover partially having insulation properties, or the like.

### (Device Busbar)

The plurality of device busbars 12 is connected to the device 11. Specifically, the device busbars 12 are electrically connected to an electrode included in the device 11.

The plurality of device busbars 12 are arranged side by side in the X direction on the first installation surface 111. As illustrated in FIG. 2, each of the device busbars 12 includes a first extending portion 121 and a first connecting portion 122. The device busbar 12 is made of a conductive material such as metal.

For example, the first extending portion 121 and the first connecting portion 122 are formed of an integrated flat metal plate. For example, each of the device busbars 12 may have a constant thickness from the first extending portion 121 to the first connecting portion 122. For example, each of the device busbars 12 may have a plate shape having a pair of surfaces facing the Z direction and the pair of surfaces of each of the device busbars 12 may extend in the Y direction from the first extending portion 121 to the first connecting portion 122.

The first extending portion 121 extends in the Y direction in contact with the 15 first installation surface 111. The first connecting portion 122 further extends in the Y direction in contact with the first installation surface 111 continuously from the first extending portion 121. The first connecting portion 122 has a first contact surface 122a on a side facing the battery unit 2. For example, the first contact surface 122a may be a plane.

### (Flange Portion)

The flange portion 13 is integrally molded with the device 11. The flange portions 13 protrude from the device 11 to both outer sides of the device 11. The flange portions 13 have a plurality of through holes 13h extending in the Z direction. The device unit 1 and the battery unit 2 are fastened together by the fastening material 3 inserted into each of the through holes 13h, whereby the device unit 1 and the battery unit 2 are unitized.

### (Configuration of Battery Unit)

The battery unit 2 includes a battery pack 21 and a plurality of battery busbars 22. In the present embodiment, a structure including a pair of each of the device busbars 12 and the relevant battery busbar 22 is also referred to as a connection structure.

### (Battery Pack)

The battery pack 21 includes a plurality of battery cells. The battery pack 21 has a second installation surface 211 on a side facing the device unit 1. The second installation surface 211 faces the first installation surface 111. For example, the second installation surface 211 may be a plane facing upward.

The battery pack 21 has a screw hole 21h in the second installation surface 211. The fastening material 3 inserted into the through hole 13h is screwed into the screw hole 21h.

The second installation surface 211 is an insulating surface made of an insulator material. For example, the second installation surface 211 may be a housing having insulation properties, a cover partially having insulation properties, or the like.

### (Battery Busbar)

The plurality of battery busbars 22 is electrically connected to the battery pack 21. Specifically, the plurality of battery busbars 22 is electrically connected to electrodes of a plurality of battery cells included in the battery pack 21.

The plurality of battery busbars 22 are arranged side by side in the X direction on the second installation surface 211. Each of the battery busbars 22 is disposed at a position facing the relevant device busbar 12. Each of the battery busbars 22 includes a second extending portion 221 and a second connecting portion 222. The battery busbar 22 is made of a conductive material such as metal.

For example, the second extending portion 221 and the second connecting portion 222 are formed of an integrated metal plate having a shape in which a flat plate is bent in the middle. For example, each of the battery busbars 22 may have a constant thickness from the second extending portion 221 to the second connecting portion 222. For example, each of the battery busbars 22 may have a plate shape having a pair of surfaces facing a direction parallel to a YZ plane, in other words, the pair of surfaces of each of the battery busbars 22 being orthogonal to the YZ plane, and the pair of surfaces of each of the battery busbars 22 may extend from the second extending portion 221 to the second connecting portion 222 while being bent so that the pair of surfaces of each of the battery busbars 22 maintains a state of facing the direction parallel to the YZ plane, in other words, a state in which the pair of surfaces of each of the battery busbars 22 is orthogonal to the YZ plane.

The second extending portion 221 extends in the Y direction in contact with the second installation surface 211. The second connecting portion 222 further extends in the Y direction continuously from the second extending portion 221. The second connecting portion 222 can be connected to the first connecting portion 122 by coming into contact with the relevant first connecting portion 122. The second connecting portion 222 is disposed at a position overlapping with the relevant first connecting portion 122 when viewed from the Z direction. A gap AA is formed between the second connecting portion 222 and the second installation surface 211.

The second connecting portion 222 includes a second contact portion 2221 and a second deformation portion 2222 in this order from a tip end of the second connecting portion 222 toward the second extending portion 221. The second contact portion 2221 and the second deformation portion 2222 are continuous with each other. In the present embodiment, the gap AA is formed between the second contact portion 2221 and the second installation surface 211 between the second connecting portion 222 and the second installation surface 211 so as to extend from a tip end of the second contact portion 2221 to the second deformation portion 2222.

The second contact portion 2221 has a second contact surface 2221a facing the relevant first contact surface 122a on a side facing the device unit 1. For example, the second contact surface 2221a may be a plane.

The second deformation portion 2222 connects the second extending portion 221 and the second contact portion 2221 to each other. The second deformation portion 2222 is elastically deformable with respect to a pressing force that the second contact surface 2221a receives from the first contact surface 122a.

Hereinafter, the “second deformation portion” is a “portion allowing deformation with respect to a pressing force that the second contact surface receives from the first contact surface”.

In the present embodiment, the second deformation portion 2222 is bent and extends from the second extending portion 221 toward the second contact portion 2221.

The second deformation portion 2222 is bent and extends in an obliquely upward direction forming an acute angle with respect to a direction (the Y direction) in which the second extending portion 221 extends toward the second contact portion 2221. In other words, the second deformation portion 2222 connects the second extending portion 221 and the second contact portion 2221 to each other so as to extend in a direction away from the second installation surface 211. The second deformation portion 2222 is bent and extends in an obliquely upward direction forming an acute angle with respect to the second installation surface 211 from the second extending portion 221 toward the second contact portion 2221. With such a second deformation portion 2222, each of the battery busbars 22 is configured such that the second connecting portion 222 extends further forward from an end of extension of the second extending portion 221.

### (Fastening Material)

A plurality of the fastening materials 3 fastens the device unit 1 and the battery unit 2 to each other. For example, each of the fastening materials 3 may be a bolt to be fastened to the screw hole 21h through the through hole 13h.

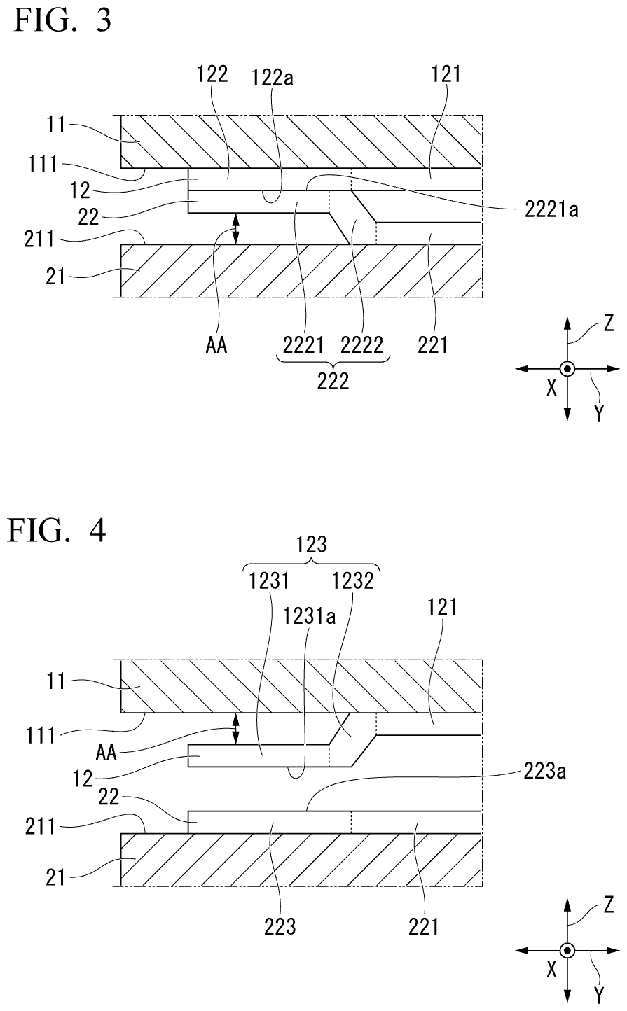

As illustrated in FIG. 3, in assembling the assembly 9, for example, when the device unit 1 is fastened to the battery unit 2 by the fastening materials 3 so as to bring the device unit 1 close to the battery unit 2, the second contact surface 2221a comes into contact with the first contact surface 122a. When the device unit 1 is further fastened, the second contact surface 2221a receives a pressing force downward from the first contact surface 122a.

Since the gap AA is formed between the second connecting portion 222 and the second installation surface 211, the second contact portion 2221 that has received the pressing force elastically deforms the second deformation portion 2222 while reducing the gap AA. On the other hand, the elastically deformed second deformation portion 2222 can apply a biasing force toward the first contact surface 122a to the second contact portion 2221. Due to this deformation and biasing force, in the assembly 9 after being assembled, the second connecting portion 222 can come into contact with the first connecting portion 122 while absorbing the pressing force from the first connecting portion 122 by the gap AA.

### (Operation and Effect of the Invention)

According to the assembly 9 of the present embodiment, the second connecting portion 222 can come into contact with the first connecting portion 122 while absorbing the pressing force from the first connecting portion 122 by the gap AA. With such a contact, the assembly 9 can absorb a manufacturing tolerance related to connection between the first connecting portion 122 and the second connecting portion 222, which is likely to occur at the time of assembling the device unit and the battery pack. Therefore, the assembly 9 of the present embodiment easily ensures contact pressure between the first connecting portion 122 and the second connecting portion 222.

For example, the assembly 9 can absorb a tolerance related to a dimensional error, a fastening pressure error, or the like between lots of various structures related to contact between the first connecting portion 122 and the second connecting portion 222 for the plurality of assemblies 9 having different lots. For example, the assembly 9 can absorb a tolerance related to a dimensional error between the plurality of device busbars 12, a dimensional error between the plurality of battery busbars 22, or the like, for one assembly 9. For example, the assembly 9 can absorb a tolerance related to a variation in contact pressure generated due to non-uniformity of fastening pressure, that is, the variation in contact pressure across the plurality of first connecting portions 122 and the plurality of second connecting portions 222, for one assembly 9.

As a comparative example, it is assumed that the structure of an assembly is a structure in which a connector is disposed in a battery pack and a vehicle body side connector and a battery side connector are connected to each other when the battery pack is attached to a vehicle body as in Japanese Unexamined Patent Application, First Publication No. 2018-144524. With such a structure of the comparative example, when there is a plurality of connecting portions, a fitting state of each connector cannot be confirmed; thus, there may be a semi-fitted connector, a very large insertion force may be required at the time of collective connection, or component cost may be high.

In contrast to this comparative example, in the present embodiment, the assembly 9 has a structure in which the second connecting portion 222 can come into contact with the first connecting portion 122 while absorbing the pressing force from the first connecting portion 122 by the gap AA. With this structure, even when there is a plurality of connecting portions, it is easy to ensure contact pressure between each of the first connecting portions 122 and the relevant second connecting portion 222 while suppressing a fastening pressure and the number of components.

In particular, when the device 11 is a high-voltage device, an electrical connection between the device unit 1 and the battery unit 2, which becomes a connection between busbars, increases, and thus it is effective to ensure the contact pressure between the first connecting portion 122 and the second connecting portion 222 as in the present embodiment.

In addition, according to an example of the assembly 9 of the present embodiment, since the second connecting portion 222 includes the second deformation portion 2222, the assembly 9 has a structure in which the second deformation portion 2222 is more likely to be deformed preferentially than the second contact portion 2221. According to such a structure, the second contact portion 2221 can apply a biasing force toward the first connecting portion 122 while having a structure in which the second contact portion 2221 itself is hardly deformed. Therefore, the assembly 9 of the present embodiment can stabilize contact between the first connecting portion 122 and the second connecting portion 222.

In addition, according to an example of the assembly 9 of the present embodiment, each of the battery busbars 22 is configured such that the second connecting portion 222 extends further forward from an end of extension of the second extending portion 221. According to such a configuration, the second contact portion 2221 can apply a biasing force toward the first connecting portion 122 while having a structure in which the second connecting portion 222 is easily processed and the second contact portion 2221 itself is hardly deformed.

### (Modification of Gap Position)

In the present embodiment, the gap AA is formed between the second connecting portion 222 and the second installation surface 211. Note that it is not limited to such a position, and the gap AA may be formed at any position as long as the gap AA can absorb a pressing force between the second connecting portion 222 and the first connecting portion 122. As a modification, the gap AA may be formed between the first connecting portion and the first installation surface. As this modification, as illustrated in FIG. 4, each of the device busbars 12 may include a first connecting portion 123 instead of the first connecting portion 122. On the other hand, each of the battery busbars 22 may include a second connecting portion 223 instead of the second connecting portion 222.

That is, in the present modification, each of the battery busbars 22 includes the second extending portion 221 and the second connecting portion 223. The second connecting portion 223 further extends in the Y direction in contact with the second installation surface 211 continuously from the second extending portion 221. The second connecting portion 223 has a second contact surface 223a on a side facing the device unit 1. For example, the second contact surface 223a may be a plane.

In addition, in the present modification, each of the device busbars 12 includes the first extending portion 121 and the first connecting portion 123. The first connecting portion 123 further extends in the Y direction continuously from the first extending portion 121. The first connecting portion 123 can be connected to the second connecting portion 223 by coming into contact with the relevant second connecting portion 223. The first connecting portion 123 is disposed at a position overlapping with the relevant second connecting portion 223 when viewed from the Z direction. A gap AA is formed between the first connecting portion 123 and the first installation surface 111.

The first connecting portion 123 includes a first contact portion 1231 and a first deformation portion 1232 in this order from a tip end of the first connecting portion 123 toward the first extending portion 121. The first contact portion 1231 and the first deformation portion 1232 are continuous with each other. In the present modification, the gap AA is formed between the first contact portion 1231 and the first installation surface 111 between the first connecting portion 123 and the first installation surface 111 so as to extend from a tip end of the first contact portion 1231 to the first deformation portion 1232.

The first contact portion 1231 has a first contact surface 1231a facing the relevant second contact surface 223a on a side facing the battery unit 2. For example, the first contact surface 1231a may be a plane.

The first deformation portion 1232 connects the first extending portion 121 and the first contact portion 1231 to each other. The first deformation portion 1232 is elastically deformable with respect to a pressing force that the first contact surface 1231a receives from the second contact surface 223a.

Hereinafter, the “first deformation portion” is a “portion allowing deformation with respect to a pressing force that the first contact surface receives from the second contact surface”.

In the present modification, the first deformation portion 1232 is bent and extends from the first extending portion 121 toward the first contact portion 1231. The first deformation portion 1232 is bent and extends in an obliquely downward direction forming an acute angle with respect to a direction (the Y direction) in which the first extending portion 121 extends toward the first contact portion 1231. In other words, the first deformation portion 1232 connects the first extending portion 121 and the first contact portion 1231 to each other so as to extend in a direction away from the first installation surface 111. The first deformation portion 1232 is bent and extends in an obliquely downward direction forming an acute angle with respect to the first installation surface 111 from the first extending portion 121 toward the first contact portion 1231. With such a first deformation portion 1232, each of the device busbars 12 is configured such that the first connecting portion 123 extends further forward from an end of extension of the first extending portion 121.

According to the assembly 9 of the present modification, the first connecting portion 123 can come into contact with the second connecting portion 223 while absorbing the pressing force from the second connecting portion 223 by the gap AA. With such a contact, the assembly 9 can absorb a manufacturing tolerance related to connection between the first connecting portion 123 and the second connecting portion 223, which is likely to occur at the time of assembling the device unit and the battery pack. Therefore, the assembly 9 of the present modification easily ensures contact pressure between the first connecting portion 123 and the second connecting portion 223.

In addition, according to an example of the assembly 9 of the present modification, since the first connecting portion 123 includes the first deformation portion 1232, the assembly 9 has a structure in which the first deformation portion 1232 is more likely to be deformed preferentially than the first contact portion 1231. According to such a structure, the first contact portion 1231 can apply a biasing force toward the second connecting portion 223 while having a structure in which the first contact portion 1231 itself is hardly deformed. Therefore, contact between the first connecting portion 123 and the second connecting portion 223 can be stabilized.

In addition, according to an example of the assembly 9 of the present modification, each of the device busbars 12 is configured such that the first connecting portion 123 extends further forward from an end of extension of the first extending portion 121. According to such a configuration, the first contact portion 1231 can apply a biasing force toward the second connecting portion 223 while having a structure in which the first connecting portion 123 is easily processed and the first contact portion 1231 itself is hardly deformed.

### Second Embodiment

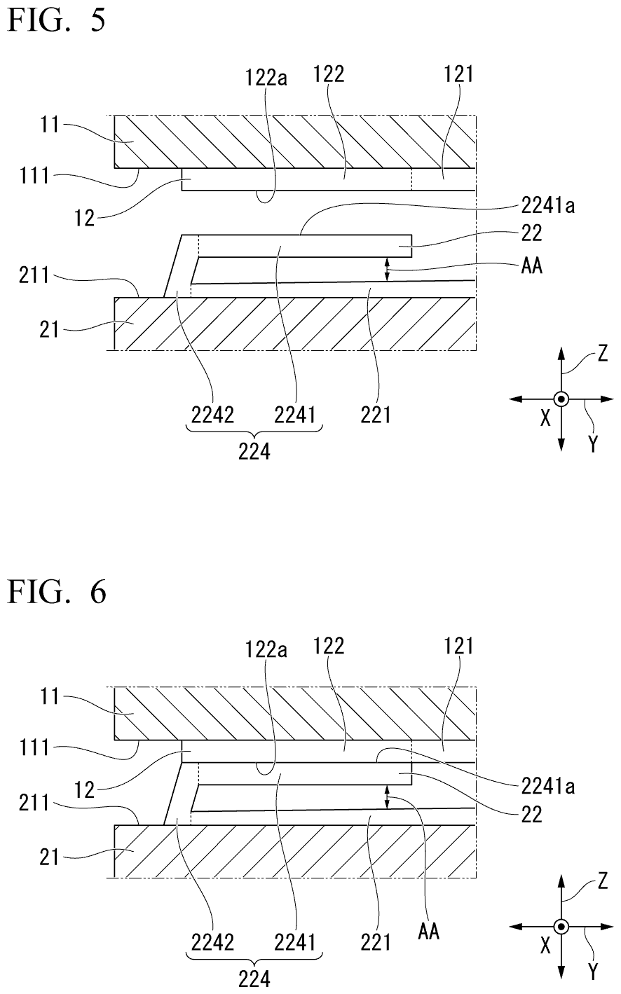

Hereinafter, an assembly according to an embodiment will be described with reference to FIGS. 5 to 7. The assembly of the present embodiment has a similar configuration, is assembled in a similar manner, and exhibits similar operation and effect to the assembly of the first embodiment except for the following points.

As illustrated in FIG. 5, in the present embodiment, each of battery busbars 22 includes a second extending portion 221 and a second connecting portion 224. For example, the second extending portion 221 and the second connecting portion 224 are formed of an integrated metal plate having a shape in which a flat plate is bent in the middle. For example, each of the battery busbars 22 may have a constant thickness from the second extending portion 221 to the second connecting portion 224. For example, each of the battery busbars 22 may have a plate shape having a pair of surfaces facing a direction parallel to a YZ plane, in other words, the pair of surfaces of each of the battery busbars 22 being orthogonal to the YZ plane, and the pair of surfaces of each of the battery busbars 22 may extend from the second extending portion 221 to the second connecting portion 224 while being bent so that the pair of surfaces of each of the battery busbars 22 maintains a state of facing the direction parallel to the YZ plane, in other words, a state in which the pair of surfaces of each of the battery busbars 22 is orthogonal to the YZ plane.

The second connecting portion 224 can be connected to the first connecting portion 122 by coming into contact with the relevant first connecting portion 122. The second connecting portion 224 is disposed at a position overlapping with the relevant first connecting portion 122 when viewed from the Z direction. A gap AA is formed between the second connecting portion 224 and a second installation surface 211.

The second connecting portion 224 includes a second contact portion 2241 and a second deformation portion 2242 in this order from a tip end of the second connecting portion 224 toward the second extending portion 221. The second contact portion 2241 and the second deformation portion 2242 are continuous with each other. In the present embodiment, the gap AA is formed between the second contact portion 2241 and the second extending portion 221 between the second connecting portion 224 and the second installation surface 211 so as to extend from a tip end of the second contact portion 2241 to the second deformation portion 2242.

The second contact portion 2241 has a second contact surface 2241a facing a relevant first contact surface 122a on a side facing the device unit 1. For example, the second contact surface 2241a may be a plane.

The second deformation portion 2242 connects the second extending portion 221 and the second contact portion 2241 to each other. The second deformation portion 2242 is elastically deformable with respect to a pressing force that the second contact surface 2241a receives from the first contact surface 122a.

In the present embodiment, the second deformation portion 2242 is bent and extends from the second extending portion 221 toward the second contact portion 2241. The second deformation portion 2242 is bent and extends in an obliquely upward direction forming an obtuse angle with respect to a direction (the Y direction) in which the second extending portion 221 extends toward the second contact portion 2241. In other words, the second deformation portion 2242 connects the second extending portion 221 and the second contact portion 2241 to each other so as to extend in a direction away from the second installation surface 211. The second deformation portion 2242 is bent and extends in an obliquely upward direction forming an obtuse angle with respect to the second installation surface 211 from the second extending portion 221 toward the second contact portion 2241. With such a second deformation portion 2242, each of the battery busbars 22 is configured such that the second connecting portion 224 extends by folding back from an end of extension of the second extending portion 221.

As illustrated in FIG. 6, in assembling the assembly 9, for example, when the device unit 1 is fastened to the battery unit 2 by the fastening materials 3 so as to bring the device unit 1 close to the battery unit 2, the second contact surface 2241a comes into contact with the first contact surface 122a. When the device unit 1 is further fastened, the second contact surface 2241a receives a pressing force downward from the first contact surface 122a.

Since the gap AA is formed between the second connecting portion 224 and the second extending portion 221, the second contact portion 2241 that has received the pressing force elastically deforms the second deformation portion 2242 while reducing the gap AA. On the other hand, the elastically deformed second deformation portion 2242 can apply a biasing force toward the first contact surface 122a to the second contact portion 2241. Due to this deformation and biasing force, in the assembly 9 after being assembled, the second connecting portion 224 can come into contact with the first connecting portion 122 while absorbing the pressing force from the first connecting portion 122 by the gap AA.

### (Operation and Effect of the Invention)

According to the assembly 9 of the present embodiment, the second connecting portion 224 can come into contact with the first connecting portion 122 while absorbing the pressing force from the first connecting portion 122 by the gap AA. With such a contact, the assembly 9 can absorb a manufacturing tolerance related to connection between the first connecting portion 122 and the second connecting portion 224, which is likely to occur at the time of assembling the device unit and the battery pack. Therefore, the assembly 9 of the present embodiment easily ensures contact pressure between the first connecting portion 122 and the second connecting portion 224.

In addition, according to an example of the assembly 9 of the present embodiment, since the second connecting portion 224 includes the second deformation portion 2242, the assembly 9 has a structure in which the second deformation portion 2242 is more likely to be deformed preferentially than the second contact portion 2241. According to such a structure, the second contact portion 2241 can apply a biasing force toward the first connecting portion 122 while having a structure in which the second contact portion 2241 itself is hardly deformed. Therefore, the assembly 9 of the present embodiment can stabilize contact between the first connecting portion 122 and the second connecting portion 224.

In addition, according to an example of the assembly 9 of the present embodiment, each of the battery busbars 22 is configured such that the second connecting portion 224 extends by folding back from an end of extension of the second extending portion 221. According to such a structure, the second contact portion 2241 can apply a biasing force toward the first connecting portion 122 while having a structure in which the second connecting portion 224 is compactly housed with respect to the second extending portion 221 and the second contact portion 2241 itself is hardly deformed.

### (Modification of Gap Position)

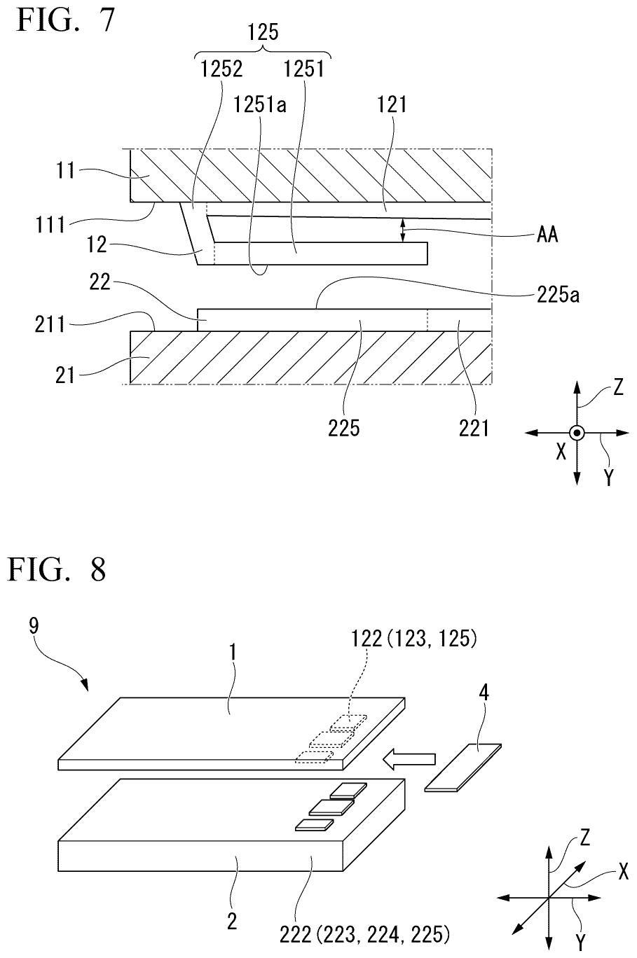

In the present embodiment, the gap AA is formed between the second connecting portion 224 and the second extending portion 221. Note that it is not limited to such a position, and the gap AA may be formed at any position as long as the gap AA can absorb a pressing force between the second connecting portion 224 and the first connecting portion 122. As a modification, the gap AA may be formed between the first connecting portion and the first extending portion. As this modification, as illustrated in FIG. 7, each of the device busbars 12 may include a first connecting portion 125 instead of the first connecting portion 122. On the other hand, each of the battery busbars 22 may include a second connecting portion 225 instead of the second connecting portion 224.

That is, in the present modification, each of the battery busbars 22 includes the second extending portion 221 and the second connecting portion 225. For example, the second extending portion 221 and the second connecting portion 225 are formed of an integrated flat metal plate. For example, each of the battery busbars 22 may have a constant thickness from the second extending portion 221 to the second connecting portion 225. For example, each of the battery busbars 22 may have a plate shape having a pair of surfaces facing the Z direction and the pair of surfaces of each of the battery busbars 22 may extend in the Y direction from the second extending portion 221 to the second connecting portion 225.

The second connecting portion 225 further extends in the Y direction in contact with the second installation surface 211 continuously from the second extending portion 221. The second connecting portion 225 has a second contact surface 225a on a side facing the device unit 1. For example, the second contact surface 225a may be a plane.

In addition, in the present modification, each of the device busbars 12 includes a first extending portion 121 and a first connecting portion 125. For example, the first extending portion 121 and the first connecting portion 125 are formed of an integrated metal plate having a shape in which a flat plate is bent in the middle. For example, each of the device busbars 12 may have a constant thickness from the first extending portion 121 to the first connecting portion 125. For example, each of the device busbars 12 may have a plate shape having a pair of surfaces facing a direction parallel to a YZ plane, in other words, the pair of surfaces of each of the device busbars 12 being orthogonal to the YZ plane, and the pair of surfaces of each of the device busbars 12 may extend from the first extending portion 121 to the first connecting portion 125 while being bent so that the pair of surfaces of each of the device busbars 12 maintains a state of facing the direction parallel to the YZ plane, in other words, a state in which the pair of surfaces of each of the device busbars 22 is orthogonal to the YZ plane.

The first connecting portion 125 extends continuously from the first extending portion 121. The first connecting portion 125 can be connected to the second connecting portion 225 by coming into contact with the relevant second connecting portion 225. The first connecting portion 125 is disposed at a position overlapping with the relevant second connecting portion 225 when viewed from the Z direction. A gap AA is formed between the first connecting portion 125 and a first installation surface 111.

The first connecting portion 125 includes a first contact portion 1251 and a first deformation portion 1252 in this order from a tip end of the first connecting portion 125 toward the first extending portion 121. The first contact portion 1251 and the first deformation portion 1252 are continuous with each other. In the present modification, the gap AA is formed between the first contact portion 1251 and the first extending portion 121 between the first connecting portion 125 and the first installation surface 111 so as to extend from a tip end of the first contact portion 1251 to the first deformation portion 1252.

The first contact portion 1251 has a first contact surface 1251a facing the relevant second contact surface 225a on a side facing the battery unit 2. For example, the first contact surface 1251a may be a plane.

The first deformation portion 1252 connects the first extending portion 121 and the first contact portion 1251 to each other. The first deformation portion 1252 is elastically deformable with respect to a pressing force that the first contact surface 1251a receives from the second contact surface 225a.

In the present modification, the first deformation portion 1252 is bent and extends from the first extending portion 121 toward the first contact portion 1251. The first deformation portion 1252 is bent and extends in an obliquely downward direction forming an obtuse angle with respect to a direction (the Y direction) in which the first extending portion 121 extends toward the first contact portion 1251. In other words, the first deformation portion 1252 connects the first extending portion 121 and the first contact portion 1251 to each other so as to extend in a direction away from the first installation surface 111. The first deformation portion 1252 is bent and extends in an obliquely downward direction forming an obtuse angle with respect to the first installation surface 111 from the first extending portion 121 toward the first contact portion 1251. With such a first deformation portion 1252, each of the device busbars 12 is configured such that the first connecting portion 125 extends by folding back from an end of extension of the first extending portion 121.

According to the assembly 9 of the present modification, the first connecting portion 125 can come into contact with the second connecting portion 225 while absorbing the pressing force from the second connecting portion 225 by the gap AA. With such a contact, the assembly 9 can absorb a manufacturing tolerance related to connection between the first connecting portion 125 and the second connecting portion 225, which is likely to occur at the time of assembling the device unit and the battery pack. Therefore, the assembly 9 of the present modification easily ensures contact pressure between the first connecting portion 125 and the second connecting portion 225.

In addition, according to an example of the assembly 9 of the present modification, since the first connecting portion 125 includes the first deformation portion 1252, the assembly 9 has a structure in which the first deformation portion 1252 is more likely to be deformed preferentially than the first contact portion 1251. According to such a structure, the first contact portion 1251 can apply a biasing force toward the second connecting portion 225 while having a structure in which the first contact portion 1251 itself is hardly deformed. Therefore, contact between the first connecting portion 125 and the second connecting portion 225 can be stabilized.

In addition, according to an example of the assembly 9 of the present modification, each of the device busbars 12 is configured such that the first connecting portion 125 extends by folding back from an end of extension of the first extending portion 121. According to such a structure, the first contact portion 1251 can apply a biasing force toward the second connecting portion 225 while having a structure in which the first connecting portion 125 is compactly housed with respect to the first extending portion 121 and the first contact portion 1251 itself is hardly deformed.

### Other Modifications

In the first embodiment described above, the first connecting portion 122 can be connected to the second connecting portion 222 by coming into contact with the relevant second connecting portion 222. Note that the assembly 9 may be configured in any manner as long as the first connecting portion 122 can be connected to the second connecting portion 222. As a modification, as illustrated in FIG. 8, the assembly 9 may include a conductive member 4 (relay conductor). The conductive member 4 extends in the X direction over a plurality of pairs of the first connecting portion 122 and the second connecting portion 222. The conductive member 4 is collectively inserted between the first connecting portion 122 and the second connecting portion 222 over the plurality of pairs of the first connecting portion 122 and the second connecting portion 222. The conductive member 4 is made of a conductive material such as metal. According to such a conductive member 4, the plurality of first connecting portions 122 and the plurality of second connecting portions 222 are connected to each other via the conductive member 4, whereby the conductive member 4 can collectively connect the plurality of first connecting portions 122 and second connecting portions 222 to each other. Also, between the first connecting portion 123 and the second connecting portion 223 in the modification of the first embodiment, the assembly 9 may include a similar conductive member 4. Also, between the first connecting portion 122 and the second connecting portion 224 in the second embodiment, the assembly 9 may include a similar conductive member 4. Also, between the first connecting portion 125 and the second connecting portion 225 in the modification of the second embodiment, the assembly 9 may include a similar conductive member 4.

In each of the above-described embodiments, the first extending portion extends in the Y direction. Note that it is not limited to such a direction, and the first extending portion may extend in any direction as long as the first extending portion extends continuously with the first connecting portion in contact with the first installation surface. As a modification, the first extending portion may extend in the X direction.

In each of the above-described embodiments, the second extending portion extends in the Y direction. Note that it is not limited to such a direction, and the second extending portion may extend in any direction as long as the second extending portion extends continuously with the second connecting portion in contact with the second installation surface. As a modification, the second extending portion may extend in the X direction.

In the assembly 9 of each of the above-described embodiments, the device unit 1 and the battery unit 2 may be exposed, but may have covers. As a modification, when each of the device unit 1 and the battery unit 2 has a cover, the cover on the device unit 1 side may have a flange having a hole for fastening the device unit 1 to the battery unit 2. Furthermore, a packing may be attached to the flange, and the packing and the cover on the high-voltage device side may ensure waterproof of the connection structure. As another modification, when each of the device unit 1 and the battery unit 2 does not have a cover, the device unit 1 and the battery unit 2 may be combined, and then the whole of the device unit 1 and the battery unit 2 may be covered with a cover. In the assembly 9 of each of the above-described embodiments, positioning of the device unit 1 with respect to the battery unit 2 (or the battery unit 2 with respect to the device unit 1) in the XY plane is performed by the plurality of fastening materials 3, but may be performed by another positioning mechanism. As a modification, a positioning through hole may be formed in the flange portion 13, and on the other hand, a positioning protrusion may be formed at a corresponding position on the second installation surface 211 of the battery unit 2. Assemblability is improved by using the positioning through hole and the positioning projection for positioning. Conversely, a positioning protrusion may be formed in the flange portion 13, and a positioning through hole may be formed at a corresponding position on the second installation surface 211 of the battery unit 2. As another modification, a positioning protruding portion may be formed on one of the first contact surface of the device busbar 12 and the second contact surface of the battery busbar 22, and a positioning recessed portion may be formed on one of the first contact surface of the device busbar 12 and the second contact surface of the battery busbar 22.

In the assembly 9 of each of the above-described embodiments, the first deformation portion is bent and extends from the first extending portion toward the first contact portion. Note that the first deformation portion may be configured in any manner as long as the first deformation portion has a structure that is elastically deformable with respect to a pressing force that the first contact surface receives from the second contact surface, and a deformation portion can be specified instead of the entire device busbar being deformed. As a modification, the first deformation portion may locally have a protruding shape. As another modification, the first deformation portion may be a stacked busbar in which thinner busbars than the first extending portion and the first contact portion are stacked. As still another modification, the first deformation portion may be a portion having a material that is more easily deformed or a portion having a smaller thickness than the first extending portion and the first connecting portion. For example, when the material of the first extending portion and the first connecting portion is aluminum, the material of the first deformation portion may be copper as a material that is easily deformed.

In the assembly 9 of each of the above-described embodiments, the second deformation portion is bent and extends from the second extending portion toward the second contact portion. Note that the second deformation portion may be configured in any manner as long as the second deformation portion has a structure that is elastically deformable with respect to a pressing force that the second contact surface receives from the first contact surface, and a deformation portion can be specified instead of the entire battery busbar being deformed. As a modification, the second deformation portion may locally have an undulating shape. As another modification, the second deformation portion may have a structure that includes a stacked busbar in which thinner busbars than the second extending portion and the second contact portion are stacked. As still another modification, the second deformation portion may be a portion having a material that is more easily deformed or a portion having a smaller thickness than the second extending portion and the second connecting portion. For example, when the material of the first extending portion and the first connecting portion is aluminum, the material of the first deformation portion may be copper as a material that is easily deformed.

In the assembly 9 of each of the above-described embodiments, the first contact surface and the second contact surface are in contact with each other, but either one may be larger than the other. When one is larger than the other, it is easy to ensure a contact area necessary for conduction even against positional deviation during assembling.

In an example of the assembly 9 of each of the above-described embodiments, the device unit 1 and the battery unit 2 are fastened by the fastening material 3 which is a bolt. Note that the assembly 9 may be configured in any manner as long as the device unit 1 and the battery unit 2 can be fixed to each other. As a modification, in a state where the device unit 1 side is pressed against the battery unit 2, metal cases of both units may be welded or resin cases of both units may be welded.

In the assembly 9 of each of the above-described embodiments, the gap AA is formed by bending the first deformation portion of each of the device busbars 12 or the second deformation portion of each of the battery busbars 22. Note that the assembly 9 may be configured in any manner as long as the gap AA is formed. As a modification, the gap AA may be formed by the first installation surface 111 being warped so as to be separated from each of the device busbars 12 or being recessed so as to be separated from each of the device busbars 12. As another modification, the gap AA may be formed by the second installation surface 211 being warped so as to be separated from each of the battery busbars 22 or being recessed so as to be separated from each of the battery busbars 22. Furthermore, each of the device busbars 12 does not have to include the first deformation portion as long as each of the device busbars 12 can absorb a pressing force in the entire portion where such a gap AA is formed. Similarly, each of the battery busbars 22 does not have to include the second deformation portion as long as each of the battery busbars 22 can absorb a pressing force in the entire portion where such a gap AA is formed.

The assembly 9 of each of the above-described embodiments has the gap AA at least either between the first installation surface and the first connecting portion or between the second installation surface and the second connecting portion, but may have the gap AA both between the first installation surface and the first connecting portion and between the second installation surface and the second connecting portion.

The assembly 9 of each of the above-described embodiments has the gap AA at least either between the first installation surface and the first connecting portion or between the second installation surface and the second connecting portion. Note that, in the assembly 9, an insulating elastic member may be inserted into the gap AA in at least a part of the gap AA. By the elastic member being inserted, the assembly 9 can ensure an appropriate contact pressure.

While the embodiments of the present disclosure have been described above, it should be understood that these are exemplary of the present disclosure and are not to be considered as limiting. These embodiments can be implemented in various other forms, and various omissions, substitutions, and other modifications can be made without departing from the scope of the present disclosure. Accordingly, the invention is not to be considered as being limited by the foregoing description, and is only limited by the scope of the appended claims.

### Industrial Applicability

According to the assembly of the present disclosure, it is easy to ensure contact pressure between connecting portions.

### DESCRIPTION OF THE REFERENCE SYMBOLS

1 Device unit
2 Battery unit
3 Fastening material
4 Conductive member (relay conductor)
9 Assembly
11 Device
12 Device busbar
13 Flange portion
13h Through hole
21 Battery pack
21h Screw hole
22 Battery busbar
111 First installation surface
121 First extending portion
122 First connecting portion
122a First contact surface
123 First connecting portion
125 First connecting portion
211 Second installation surface
221 Second extending portion
222 Second connecting portion
223 Second connecting portion
223a Second contact surface
224 Second connecting portion
225 Second connecting portion
225a Second contact surface
1231 First contact portion
1231a First contact surface
1232 First deformation portion
1251 First contact portion
1251a First contact surface
1252 First deformation portion
2221 Second contact portion
2221a Second contact surface
2222 Second deformation portion
2241 Second contact portion
2241a Second contact surface
2242 Second deformation portion
AA Gap

What is claimed is:

1. An assembly comprising:
a device unit including a device and a device busbar, the device having a first installation surface, the device busbar including a first extending portion extending in contact with the first installation surface and a first connecting portion extending continuously from the first extending portion; and
a battery unit including a battery pack and a battery busbar, the battery pack having a second installation surface facing the first installation surface, the battery busbar including a second extending portion extending in contact with the second installation surface and a second connecting portion extending continuously from the second extending portion and connectable to the first connecting portion,
wherein a gap is formed at least one of between the first installation surface and the first connecting portion and between the second installation surface and the second connecting portion.

2. The assembly according to claim 1, wherein
a gap is formed between the second installation surface and the second connecting portion, and
the second connecting portion includes a second contact portion and a second deformation portion connecting the second extending portion and the second contact portion to each other.

3. The assembly according to claim 2, wherein
the second deformation portion connects the second contact portion and the second extending portion to each other such that the gap is formed between the second installation surface and the second connecting portion while the second connecting portion extends further forward from an end of extension of the second extending portion.

4. The assembly according to claim 2, wherein
the second deformation portion connects the second contact portion and the second extending portion to each other such that the gap is formed between the second extending portion and the second connecting portion while the second connecting portion extends by folding back from an end of extension of the second extending portion.

5. The assembly according to claim 1, wherein
a gap is formed between the first installation surface and the first connecting portion, and
the first connecting portion includes a first contact portion and a first deformation portion, the first deformation portion connecting the first extending portion and the first contact portion to each other.

6. The assembly according to claim 5, wherein
the first deformation portion connects the first contact portion and the first extending portion to each other such that the gap is formed between the first installation surface and the first connecting portion while the first connecting portion extends further forward from an end of extension of the first extending portion.

7. The assembly according to claim 5, wherein
the first deformation portion connects the first contact portion and the first extending portion to each other such that the gap is formed between the first extending portion and the first connecting portion while the first connecting portion extends by folding back from an end of extension of the first extending portion.

8. The assembly according to claim 1,
comprising a plurality of pairs of the first connecting portion and the second connecting portion, and
further comprising a relay conductor to be collectively inserted between the first connecting portion and the second connecting portion over the plurality of pairs.
